(19) United States
(12) Patent Application Publication
(10) Pub. No.: US 2002/0099679 A1
(43) Pub. Date: Jul. 25, 2002

(54) Virtual interactive expert solution system

(76) Inventors: Scott Kenneth Usitalo, Cincinnati, OH (US); Rajesh Garg, Cincinnati, OH (US); Daniel Roy Maurer, Cincinnati, OH (US); Wade Duvall Miquelon, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/767,011

(22) Filed: Jan. 22, 2001

Related U.S. Application Data
(60) Provisional application No. 60/262,910, filed on Jan. 19, 2001.

(51) Int. Cl. G06N 5/02; G06F 17/00

(52) U.S. Cl. 706/46

(57) ABSTRACT

An interactive system for creating a user workflow comprises a user workspace in selective communication with an expert knowledge module, wherein the expert knowledge module comprises a predetermined area of knowledge or expertise. The system is configured to provide a user with a solution to an identifiable user project.

This non-provisional patent application claims priority to a provisional application filed on Jan. 19, 2001 having the title “Virtual Interaction Expert Solution System” and listing the inventors as “Rajesh Garg, Daniel Maurer, Wade D. Miquelon, and Scott K. Usitalo”.

The present invention relates generally to a virtual interactive system and method for providing networked based solutions and expertise to users in a predetermined area of knowledge. More particularly, the present invention creates a workflow within a user's desktop which guides the user to find one or more solutions to an identifiable user project. The present invention especially pertains to a method, as above, for providing marketing knowledge.

### BACKGROUND OF THE INVENTION

Through telephone lines, network systems, satellite systems and other communication mechanisms, information and resources are increasingly being shared by companies and their customers and suppliers. Access to vital information and resources is being made available at anytime and from anywhere in the world allowing companies to improve time to market, reduce costs and keep members of a globalized work force in constant communication.

These changes have not only revolutionized the way companies do business, but have also created tremendous new opportunity for those with a vision to capitalize on the technological change. One such opportunity has arisen in the form of a new business model, termed Application Service Provider (ASP), which offers, for example, a specific business application on a subscription basis via the Internet or other networked arrangement. One of the primary advantages to such a business model is that the company specializing in a particular business application can leverage its infrastructure resulting in significant economies of scale. As a result, ASP's can typically provide best in class outsourced services to customers at competitive prices.

While ASP's have been developed for a multitude of business purposes such as human resource management and information technology maintenance, some have been developed to offer customers an opportunity to develop, create and deploy advertising, marketing and branding solutions. Typically, the creation, development and deployment of most of these types of solutions requires multiple parties to interact through the various stages of development and deployment. For example, advertising and marketing development may require a marketing agency to initially create a concept that might require further development and consumer testing by other agencies or by a client enduser. As a result, at almost all stages of the project development each of the various parties involved must be in constant communication, as failure to communicate invariably leads to confusion and duplicated work among the various parties involved. Consequently, one of the primary advantages of providing an Internet based solution is the ability to alleviate communication problems among the various parties involved with the project development.

While this advantage is inherent with any Internet solutions provider, it also exemplifies one of the problems typically associated with such systems. In particular, most ASP's provide limited service offerings and, in some cases, the only attraction to the service is that it is provided over the Internet. In other words, most service providers that exist today do not provide users with a complete solution to an identifiable problem. Rather, they typically offer a mechanism by which users can more effectively communicate, but fail to provide a user with other relevant information, requiring the user to look to his or her own resources or elsewhere to find a solution to a particular project.

This is primarily the case with the basic service providers that offer marketing or advertising solutions. In most of these cases, the service offerings are typically limited to hosting capabilities, which may allow multiple parties to collaborate on a project. In many other cases, however, the systems are incapable of handling graphics intensive and streaming media data that is typically associated and needed with the marketing field. Additionally, most of these system do not allow users the opportunity to develop and reassess, and modify their workflow at every stage of development of the marketing campaign. Moreover, there is no system that actually guides a user, especially on a user-matched level of assistance, to a solution to a problem based on a predetermined area of knowledge such as marketing or advertising. As a result, it would be advantageous to have a system that not only improved upon the attributes of existing systems, but also combined these attributes with an expert knowledge base which could guide a user to a solution to an identifiable marketing problem or the like.

### SUMMARY OF THE INVENTION

In an exemplary embodiment of the present invention, an interactive system for creating a user workflow comprises a user workspace in selective communication with an expert knowledge module, wherein the expert knowledge module comprises a predetermined area of knowledge or expertise. The system is configured to provide a user with a solution to an identifiable user project.

In another embodiment of the invention, an interactive system for providing a user access to a predetermined area knowledge within a user workspace comprises a user interface and an expert knowledge module comprising a predetermined area of knowledge. The system can also include a system coordinator comprising executable instructions in communication with the user interface, the expert knowledge module, and the user workspace. Moreover, the coordinator can further comprise executable instructions for providing access to the predetermined area of knowledge to guide the user toward one or more solutions to an identifiable project.

In another embodiment of the present invention, an interactive system is provided for networked based solutions and expertise to users in a predetermined area of knowledge. The system comprises a user interface, an expert knowledge module comprising a predetermined area of knowledge sufficient to guide a user to a solution of a user identifiable project, and a system coordinator comprising executable instructions. The coordinator provides selective communication with the expert database based at least in part on input from the user. Moreover, the coordinator provides output to the user interface to help the user learn about the identifiable project and to guide the user toward one or more solutions to an identified project.

An alternate embodiment of the present invention comprises a method for providing selective access to a predetermined area of knowledge within a user's workspace. The method comprises providing a user interface and providing a user workspace in communication with at least one software application module. The software application modules define the workspace and are communication with an expert knowledge module. The method further comprises accepting user input through the user interface and selecting knowledge from the expert database based on the user input. Finally, the method provides the user with access to the knowledge.

Still other objects, advantages and novel features of the present invention will become apparent to those skilled in the art from the following detailed description, which is simply, by way of illustration, various modes contemplated for carrying out the invention. As will be realized, the invention is capable of other different obvious aspects all without departing from the invention. Accordingly, the drawings and descriptions are illustrative in nature and not restrictive.

### BRIEF DESCRIPTION OF THE DRAWINGS

While the specification concludes with claims particularly pointing out and distinctly claiming the present invention, it is believed that the same will be understood from the following description taken in conjunction with the accompanying drawings in which:

FIG. 1 depicts a schematic illustration of a virtual interactive system in accordance with the present invention;

FIG. 2 depicts a more detailed exemplary schematic illustration of a virtual interactive system in accordance with the present invention,

FIG. 3 depicts an example of a decision tree architecture as contemplated by the present invention,

FIGS. 4-5 depict exemplary web screens illustrating a global framework that provides the foundation for a user to selectively accessing expert knowledge.

FIG. 6 depicts an exemplary web screen illustrating an embedded workflow;

FIG. 7. depicts a conceptual embedded workflow in accordance with an exemplary embodiment of the present invention;

FIG. 8. schematically depicts an alternate embodiment of the present invention;

FIG. 9. schematically depicts a partial, exemplary client/server diagram that might be employed to implement an embodiment of the present invention; and

FIG. 10 schematically illustrates a network system that might be employed to implement an embodiment of the present invention.

### DETAILED DESCRIPTION OF EXEMPLARY EMBODIMENTS

Reference will now be made in detail to various embodiments of the invention, various examples of which are illustrated in the accompanying drawings, wherein like numerals indicate corresponding elements throughout the views.

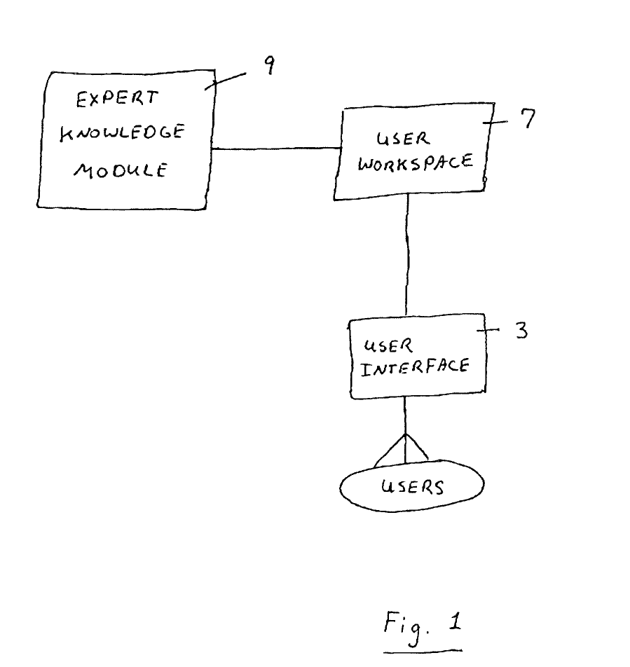

An embodiment of the present invention is schematically illustrated in FIG. 1, which depicts an interactive system 1 for managing the virtual workspace of a user on the interactive system. In a non-limiting embodiment of the present invention, the interactive system 1 is shown as comprising a user interface 3, a user workspace 7 and an expert knowledge module 9. The interactive system 1 is designed to interactively guide a user toward a solution based on the user's identifiable project by providing expert knowledge relating to the subject matter. As used herein, the term guide is contemplated to mean that the interactive system provides the user access to a step-by-step template for finding a solution to an identifiable problem. Additionally, expert knowledge is contemplated herein as comprising step-by-step templates, best practice scenarios, examples, case studies, principles, practice tips, shortcuts, tools, consumer insights and demographics, concepts, algorithms and other subject matter or training related knowledge.

For example, in a particular embodiment of the present invention, a user may be confronted with a project relating to an identifiable subject such as marketing, advertising or branding. In such a scenario, the system 1 interacts with the user and provides the user with a virtual workspace 7, as well as, allows the user to selectively access the expert knowledge module 9 for obtaining knowledge relating to the identifiable project. Such a workspace is contemplated as comprising the provision of a user interface for interactive activities via any appropriate user access scenario (e.g., a conventional desktop computer, a PDA, Internet appliance, etc.) It is further contemplated that the system 1 may also embed knowledge from the expert knowledge module 9 into the user's workspace (e.g., desktop), providing the user with a predetermined workflow for determining a solution to the project. As used herein, the term embed is contemplated to mean that expert knowledge is made accessible to the user electronically, and may also include at least temporarily making some portion of such an integral part of the user's desktop or workspace 7. Moreover, the term workflow is contemplated to mean that the guide provided by the system 1, is configured to interactively teach the user the steps necessary to solve the identifiable project. In other words, in a non-limiting embodiment of the present invention, expert knowledge regarding a particular identifiable subject is provided to user's workspace to allow the user to learn about the identifiable subject and work toward a solution to a problem relating to the subject without actively leaving the workspace or desktop.

In this regard, it should be recognized that a user will be a person undertaking an interaction with the interactive system 1. As will be described in more detail, the interactive system 1 will have the ability to recognize new or first time users and to identify existing users by a distinctive user identification record containing information such as a user name and/or team name and password. Moreover, the interactive system 1 will allow users to effectively manage their assigned projects on an individual or on a collaborative basis. For example, there may be numerous individuals involved in the development of any particular marketing or advertising campaign or project, including a marketing brand manager, several associates, various advertising or marketing agencies, and the client end-user, which may each require different levels of access to the interactive system 1. It is contemplated that in this event, the interactive system 1 will allow each of these individuals to have appropriate access to a particular project, (i.e., some projects might be read-only; some users might not have access to all projects or all information associated with a particular project, etc.) and allow these individuals to work in real-time and in a collaborative virtual workplace environment.

In particular, it is contemplated that an interactive system 1 of the invention can be operated through a web site hosted on a network such as a wide-area network, local-area network, or the Internet. For example, if the interactive system 1 were operated via the Internet, users could access the system 1 at any time and from anywhere in the world. In more detail, the Internet and World Wide Web operate on a client/server model, and a user runs a web client, or browser, on a electronic device such as a computer, personal digital assistant (PDA), cell phone, and the like. The web browser contacts a web server and requests data information, in the form of a Uniform Resource Locator (URL).

Typically, URL addresses are typed into the browser to access web pages, and URL addresses are embedded within the pages themselves to provide the hypertext links to other pages. A hypertext link allows the user to click on the link and be redirected to the corresponding web site to the URL address of the hypertext link. Many browsers exist for accessing the World Wide Web, such as Netscape Navigator from Netscape Communications Corp. and Internet Explorer from Microsoft Corp. Similarly, numerous web servers exist for providing content to the World Wide Web, such as Apache from the Apache Group, Internet Information Server from Microsoft Corp., Lotus Domino Go Webserver from IBM, Netscape Enterprise Server from Netscape Communications Corp. and Oracle Web Application Server from Oracle Corp. These browsers and web servers can be utilized to allow access to the present invention from virtually any web-accessible device.

As contemplated in FIG. 1, the user interface 3 might comprise a kiosk, a computer, a personal digital assistant (PDA), a device with wireless application programs (WAP) such as cell phone, auto computer, interactive TV, an Internet appliance, or other access device. The user interface 3 allows the user to communicate and interact with the interactive system 1 and, as will be understood, can take any of a virtually unlimited number of alternative forms. In one relatively common exemplary embodiment, the user interface 3 may comprise a computer system comprising a CPU, memory, a visual display device and a keyboard or other input device. Exemplary input means can comprise a keyboard or mouse or other means of input such as speech recognition and/or visual input utilizing a video camera. Additionally, the user interface 3 comprises a computer connected to the Internet through a communication link and running a web browser such as Internet Explorer from Microsoft Corp. or Netscape Navigator from Netscape Communications Corp.

As further illustrated in FIG. 1, it is contemplated that the interactive system 1 comprises a user workspace 7, which can be provided in the form of a desktop arrangement, or any corresponding arrangement that enables a user to access and interact with the user interface 3. It is contemplated that the user's workspace 7 provides the user with access to all the necessary tools to provide the user with a virtual work environment. In other words, the user's workspace should provide the user with the necessary resources to solve an identifiable project without actively leaving the workspace or desktop 7. It is further contemplated that the user's workspace might be further defined by a plurality of the software modules 8 which create the virtual desktop or workspace associated with the interactive system 1. In an alternative embodiment, the software modules 8 could be provided at the user interface 3 via a host server and not necessarily loaded onto a workspace at all. The software modules, many of which may be widely available as off the shelf products, may include project tracking, file management, collaboration, word processing, presentation software, video editing software or the like. It is through these modules 8 that a user or group of users can collaborate, file share, create, modify, delete, upload and download documents and other information developed by the user. For example, in an exemplary embodiment of the invention, the software modules 8, combine to allow a user to perform any function typically associated with the user's desktop. The foregoing examples of software modules 8, are provided only as exemplary examples of the mechanisms or ways through which user information can be modified, created and/or stored by the interactive system 1.

The interactive system 1 further comprises an expert knowledge module 9 that contains expert knowledge relating to an identifiable subject. From a conceptual basis, expert knowledge contained within the expert knowledge module 9 may include, but is not limited to, best practice scenarios, examples, case studies, principles, practice tips, shortcuts, tools, consumer insights and demographics, concepts, algorithms and other related knowledge pertaining to the subject area of expertise (e.g., marketing, advertising, accounting, product design, etc.). It should be recognized that the knowledge provided within the expert knowledge is capable of being categorized such as by topic, degree of difficulty, related industry, type of brand, and other factors such that upon either manual or automatic searching of the expert database, knowledge relevant to particular project can be made available to the user.

Furthermore, in a non-limiting exemplary embodiment of the present invention, the expert knowledge module 9 is provided with knowledge relating to marketing information. Marketing information is contemplated herein as comprising any information relating to successfully taking a product, initiative or brand equity building idea to market and includes advertising, marketing and/or branding knowledge. Moreover, it should be recognized that the expert knowledge module 9 might be updated on a regular basis to provide the user with the latest available knowledge on any given particular topic. In this way, the interactive system 1 will assist and challenge both the novice and the expert to develop the most complete solution to an identifiable project. As will be further discussed, a system administrator could be assigned to accomplish this task.

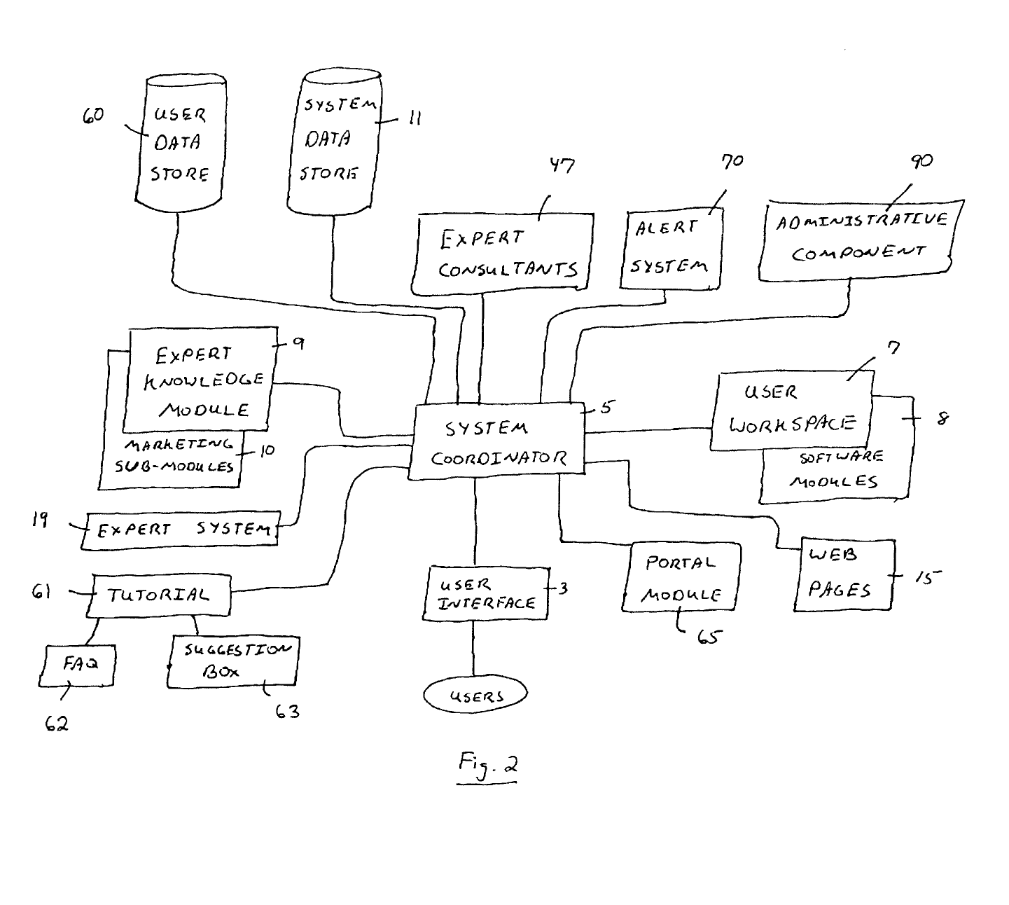

In an alternate, exemplary embodiment of the present invention as illustrated in FIG. 2, the expert knowledge module 9 may be comprised of a plurality of marketing sub-modules 10. It is herein contemplated that the term marketing sub-module 10 comprises selected knowledge relating to particular marketing information. For example, marketing sub-modules 10 may be comprised of knowledge such as tools, case studies, principles, and step-by-step templates that guide a user through go-to-market tasks that include, but are not limited to, the development, deployment, review and renewal of business and brand strategy, package design and implementation, product and advertising concept development and deployment, advertising development and deployment, consumer research methodology and techniques, media planning and deployment, storyboard training and evaluation, pricing strategy development and deployment, customer marketing plan development and deployment, promotion planning and deployment, public relations planning and deployment, creating and/or building brand equity, launching an initiative, and the like.

Moreover, It should be noted that segmenting the marketing knowledge into discrete sub-modules 10 may provide many benefits to the Internet service provider. First, the system 1 could be initially offered with a minimal number of sub-modules10, and subsequently supplemented and expanded as additional marketing information is developed. Moreover, providing knowledge based on sub-modules may provide the interactive system 1 with a flexible pricing scheme. For example, the expert knowledge could be pre-categorized within the expert knowledge module or in separate sub-modules by function, product line, industry or any other identifiable category. Then, user's could purchase subscriptions or access to sub-modules based on relevance to their particular business segment and/or budget constraints. In this way, the user might be further able to reduce the time and/or cost associated with solving the identifiable user problem as the user may have less knowledge from the expert database to review. The reduced costs and access would, of course, have to be balanced against the downside risk of reduced resources and expertise for addressing and solving assigned projects. The sub-modules can also be made available at all times on an a-la-carte basis, where users pay for features used on a per-use basis.

As will be further explained, it is contemplated that each marketing sub-module 10 might include knowledge such as a step-by-step template designed to guide a user toward a solution related to that particular sub-module. Moreover, the sub-module 10 may further contain knowledge such as cases, tools, principles and other knowledge that are related to that particular sub-module, and may be further categorized with regard to each individual stage of the step-by-step template. For example, pricing analysis for shampoo may be an example of a marketing sub-module 10 in a beauty and hair care expert knowledge module 9. In this scenario, the marketing sub-module 10 may contain a step-by-step template for the user, which guides the user through every step of determining an appropriate price for a particular brand of shampoo. The template may include, but is not limited to guiding the user through a series of questions that address the required business situation analysis, conclusions to the analysis, any indicated actions and implementation plans. For example, the step-by-step template may display a first question that needs to be answered by the user in order to suitable determine a price. The question that needs to be answered may be something like “How do I create a winning plan to launch my brand and/or initiative into market?” If the user knows the answer to the question, the user will record the answer and will subsequently move on to the second step as provided by the step-by-step template. However, the user may be unsure how to address the question. If this is the case, the user might have the option of reviewing relevant case studies, tools and/or principles that are included with the module to teach and provide examples to the user of how to appropriately address the question. It is in this way, the interactive system 1 is capable of guiding a user toward an optional solution to an identifiable problem, while simultaneously instructing the user in useful knowledge and tools of the related industry.

As further illustrated in FIG. 2, in an exemplary embodiment of the present invention, the interactive system 1 may further comprise a system coordinator 5. It is contemplated that the system coordinator 5 would likely comprise a set of executable instructions, such as in the form of software, routines, programs, algorithms, code and the like, which among other things, would control and facilitate the flow of information between the various components of the system 1. For example, in a non-limiting embodiment of the invention, the system coordinator 5 might control the flow of information to and from the user interface 3, the user workspace 7, and the expert knowledge module 9, or any of the other various components of the interactive system 1.

It should be understood that the system coordinator 5, is not limited to a single set of instructions, rather the instructions could be provided on multiple systems in various parts of the world, to accommodate for diversity in customer base and allow for a redundant and scalable system that is available at any time and from anywhere in the world. The system coordinator 5 is provided in communication with each of these elements, such as via a token ring, Ethernet, telephone modem connection, radio or microwave connection, parallel cables, serial cables, telephone lines, universal serial bus “USB”, Firewire, Bluetooth, fiber optics, infrared “IR”, radio frequency “RF” and the like, or combinations thereof. It should be further understood that the system coordinator 5 does not have to be a separate component of the interactive system 1. Rather, the functions of the system coordinator 5 could be provided as an integrated component of the user workspace 7, user interface 3 or expert knowledge module 9.

In a non-limiting embodiment of the invention, it is contemplated that the system coordinator 5 would have the ability to recognize and differentiate each user and team of users of the interactive system 1. To provide the interactive system 1 with the ability to differentiate users, the interactive system may further comprise a system data store 11 which the system coordinator 5 may utilize to store, access and modify a users individual identification record. For example, at an appropriate “log on” screen, a user may input desired identification, such as a user name or team name and password, which the system coordinator 5 might compare against information stored in the system data store 11. If a match is found, the system coordinator 5 will recognize that the user has previously been on the system. However, if no match is found, the system coordinator 5 might create a new user identification record and indicate to the user that they are recognized as a first time user in an appropriate way. Although the system coordinator 5 might require a variety of personal information from the user to create an account, it is contemplated that the identification record will require the user to input general information such as a desired user name and/or team name and password. Next, the system coordinator 5 might send the identification record to the system data storage 11 to be associated with the newly created account. The system coordinator 5 might then create a “cookie” or similar type file and store the file on the user's computer or otherwise set up a trigger system or gatekeeper arrangement to enhance the process of identifying the user upon further interactions. Other potential identification means may include IP addresses, biometrics, user passcards, swipe cards, or other identification means known in the art.

In an alternate embodiment of the invention, the system coordinator 5 may develop a more detailed identification record or may develop a separate and independent user profile which may include information such as e-mail address, place of employment, years of experience, industry affiliation, or the like. Moreover, although the user identification record and/or profile can be developed using this initial information, it should also be recognized that these records should not be limited to this user initial information. Rather, the user identification record and/or profile may be further modified by the system coordinator 5 to reflect the user's “use” or experience with the interactive system 1, their preferences, special needs, or other personal characteristics. As such, the identification record and/or profile may be added to or modified by the system coordinator 5 to further contain information such as how many times a user has been on the system, the types of projects typically undertaken by the user, the expert knowledge viewed by the user, level of assistance required or desired by the user, industry topics read by the user, and the like.

In a further non-limiting embodiment of the present invention, the system coordinator 5 is provided with access to one or more pre-determined web pages 15 for directing user interaction. Although each web page 15 of the interactive system 1 could be comprised of virtually any combination of text, “clickable” or selectable icons, links, graphics, or the like, in an exemplary embodiment of the invention, the web pages 15 should allow the user to easily interact with the interactive system 1. It should be noted that it is contemplated that the web pages 15 are stored in a database or web server, and as will be later described, can be edited and maintained by a remote system administrator.

In an exemplary embodiment, the system coordinator 5 selects web pages 15 to interact with the user based at least in part upon the user's interaction with the system 1 and upon a predetermined set of executable instructions. For example, once a user logs onto the interactive system 1, the system coordinator 5 may transmit an appropriate web page 15, such as a welcome screen to the user. Following an appropriate introductory screen or set of screens, the interactive system 1 may display an appropriate workspace screen 13. It is intended that the workspace screen 13 might conveniently provide the user with all of the necessary tools to allow the user to create and deploy an advertising and marketing campaign without leaving the desktop 7. Although, it should be recognized that the workspace screen 13 could be provided with virtually any assortment of information, text, graphics, “clickable” or selectable icons, and links, appropriate icons for the desktop 7 may include, access to Microsoft applications such as Microsoft Word and PowerPoint, an e-mail center, messaging center, file drawer, calendar, contacts, news items, approvals, Internet links, and the like. It should be recognized that any particular workspace screen 13 can be customizable by the user to allow the user the most convenient and appropriate access to the tools the user may require. User preferences can also be inserted to generate all screens in a desired format, level of detail, etc. In such an embodiment of the invention, the user would have the choice of selecting an icon from the customizable tool bar, which is transmitted to the system coordinator 5.

Since it is contemplated that the user input will be transmitted to the system coordinator 5, the system coordinator 5 may be configured with a decision tree or executable instructions to enable it to determine whether the information should be transmitted to the expert knowledge module 9, a software module 8 associated with the user workspace 7 or to any of the other various components of the interactive system 1. Such decision tree or instructions should comprise every combination of possible user input and response requirements to allow the coordinator to appropriately direct data, instructions and/or guidance to facilitate optimal work flow and progress toward the needed solution. For example, the user input might be compared against a decision tree for a matching branch and the matching branch provides further instructions to be executed as a result of the match. In an exemplary embodiment, the decision trees are converted to mathematical algorithms which then process the decision tree comparisons or “decisions” electronically to ascertain and direct the flow of information.

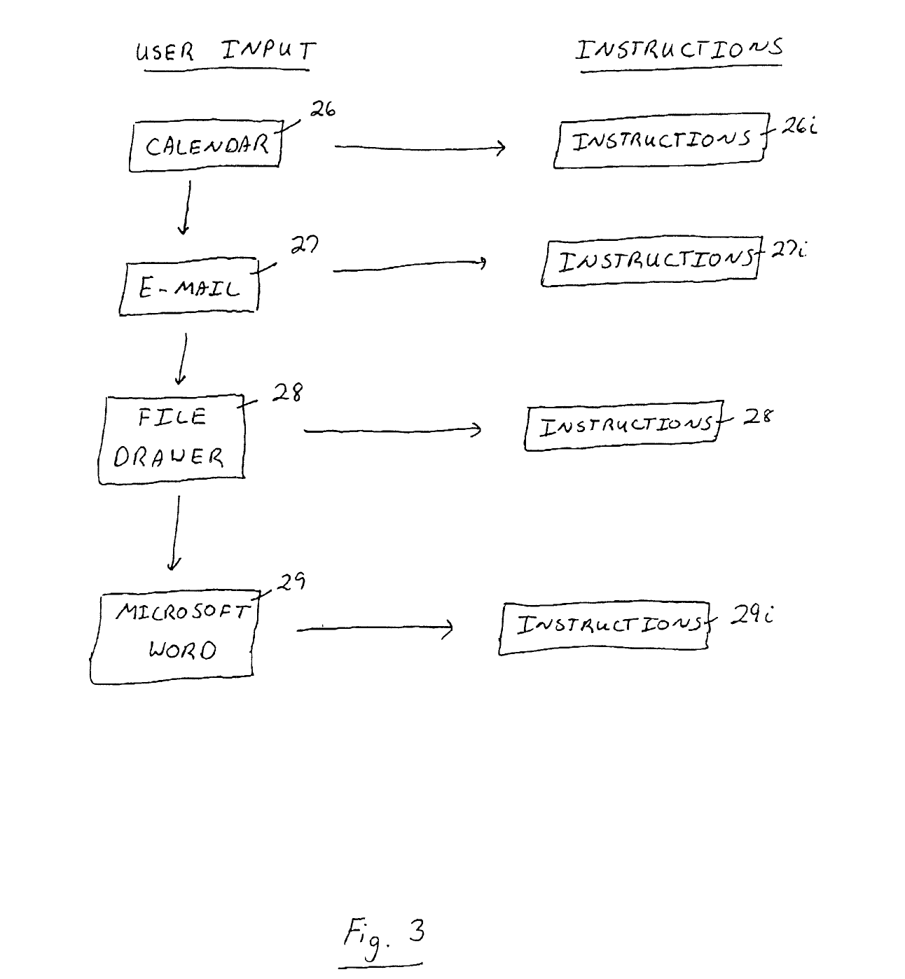

In a further exemplary and non-limiting embodiment of the present invention, a decision tree for a hypothetical workspace screen 13 might include every possible combination of icons that could be selected by the user as depicted in FIG. 3. In this embodiment, assume the workspace screen 13 has four icons available to be potentially selected by the user including: Calendar 26, E-mail 27, File Drawer 28 and Microsoft Word 29. The selection by the user is compared against the decision tree and the matching branch of the tree provides further instructions to be executed by the system coordinator 5. If, for example, the user selects an icon such as Microsoft Word 29, the system coordinator 5 matches the user input of Microsoft Word 29 against the decision tree and executes the predetermined executable instructions (i.e. 29i) associated with that branch of the tree. In this particular case, the system coordinator 5 would execute the appropriate instructions to open the Microsoft Word application for access by the user. In such scenario, it should further be recognized that a decision tree should be available for every web page 15 associated with the interactive system 1. Consequently, because every possible combination of responses has a corresponding pre-determined set of executable instructions, the system coordinator 5 is able to coordinate the flow of information and activities between the various components of the system 1.

Although, it is contemplated that the user may be allowed to manually search the expert knowledge module 9 for information relating to a particular topic, in an exemplary embodiment of the present invention, the user's workspace screen 13 may further include an “Expert” icon. The “Expert” icon is contemplated as being affiliated with an expert system 19 that comprises a set of executable instructions that allows the interactive system 1 to selectively provide the user access to expert knowledge obtained from the expert knowledge module 9 via the user's desktop or workspace 7 or via the user interface 3. It should be recognized that the executable instructions associated with the expert system 19 could be a separate component of the interactive system 1 or could be integrated with the system coordinator 5, the expert knowledge module 9, or virtually on other component of the interactive system 1.

In an exemplary embodiment of the invention, the executable instructions of the expert system are integrated with the system coordinator 5, such that upon a user selecting the “Expert” icon, from the appropriate web-page 15, the system coordinator 5 will selectively provide the user access to expert knowledge obtained from the expert knowledge module 9 via the user's desktop or workspace 7. Although it should be recognized that knowledge from the expert knowledge module 9 could be categorized, presented to, or accessed by the user in a variety of ways, in an exemplary embodiment of the invention, knowledge from the expert knowledge module 9 is categorized to provide a specific workflow to a user, which guides the user toward a solution to an identified problem. In other words, the system coordinator 5 might embed, or provide access to, a step-by-step template from the expert knowledge module 9 into the users's workspace, thereby providing a guide to the user for the user to find one or more solutions to the identifiable problem. Moreover, the knowledge could also be categorized such that principles, case studies, tools and other topics are provided at the user's discretion and in relation to a specific step of the designated workflow process.

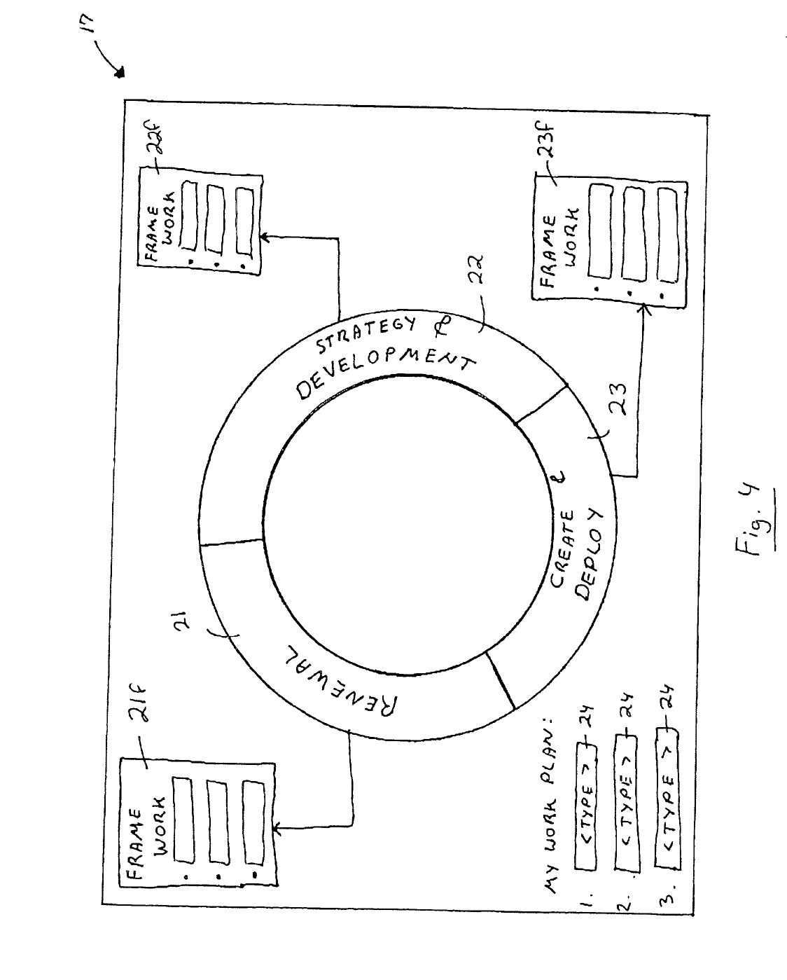

In more detail, if a user to the interactive system 1 chooses the “Expert” icon off the appropriate web page 15, the interactive system 1 might display the Expert screen 17 as depicted in FIG. 4. The Expert screen 17 might depict the global framework for all advertising and marketing development and might also provide a place for the user to input the “type” of project 24 the user wishes to develop or research. It is contemplated that the “type” of project 24 is defined by the user. For example, although there could any number of various types of projects 24, some examples in the marketing industry example may include create a strategy document complete with brand vision, business objectives, strategies, plans and measures, recommend new package graphics for brand X to better target its end users, create an advertising campaign that clearly communicates a patented reason to believe and its unique benefits, field research to determine how consumers are reacting to a products introduction to market, create a new media plan that extends brand X's weeks on air versus year ago with less cost, recommend a new product demo for Brand Z's current ad campaign, analyze Brand X's in market pricing, draw conclusions on its current effectiveness and recommend any indicated actions, recommend a co-equity marketing plan for brand X and customer Q, create and deploy and promotion plan that drives trial on brand K, develop an internal public relations strategy, establish the success criteria team B must meet prior to recommending a product A's launch to market, advertising creative development, and the like. Due to the nearly unlimited variety of possible wordings and synonyms, it is contemplated that the system coordinator 5 might be equipped with a keyword search capability that allows the system coordinator 5 to effectively match the user's input of “type” of project 24 with the knowledge that is available in the expert knowledge module 9.

As an aside, it should further be recognized that the “type” of user project 24 maybe correlated with the discrete marketing sub-modules 10 (e.g., marketing sub-modules in the marketing example) within the expert knowledge sub-module 9. For example, a marketing sub-module 10 may comprise expert knowledge relating to the development of a dot-com advertisement. The marketing sub-modules 10 may comprise a step-by-step template to creating dot-com advertising and may further comprise case studies, excerpts from treatises or text books, tools and/or principles specifically related to dot-com advertisements. Once this sub-module 10 is integrated within the expert knowledge module 9, “dot-com advertisement” should become a “type” of project 24 recognizable by the system. Moreover, it should further be recognized that the marketing sub-modules 10 may comprise multiple “types” of projects 24. Continuing with the same example, “dot-com advertisements” could relate to creating a print ad or television commercial which advertises the company to customers or could also relate to creating an effective employment campaign to draw new hires to the company. In this scenario, adding one marketing sub-module 10, may add multiple “types” of possibly overlapping and/or cross-referenced projects 24 recognizable by the system. Thus, as more and more marketing sub-modules 10 are added to the expert knowledge module 9, the user should be able to find one or more “type” of project 24 that suits his/her needs.

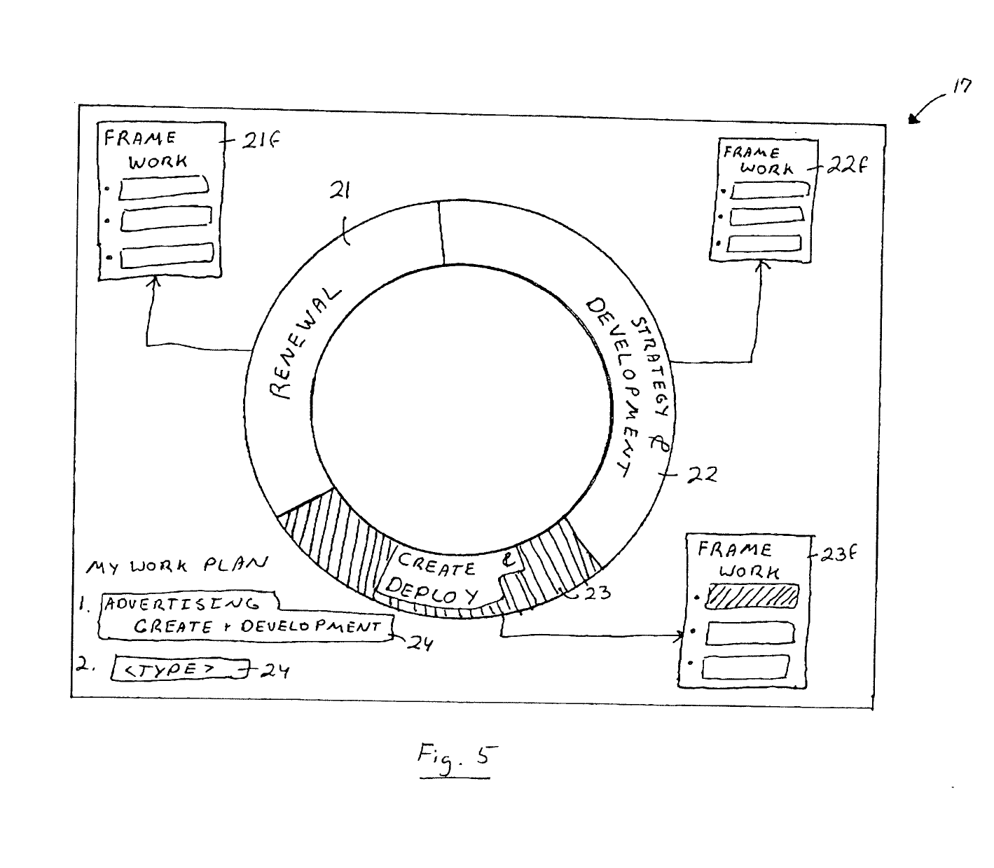

For example, assume a user inputs the “type” of project 24 as depicted in FIG. 5 as “advertising creative development”. Upon this input, the system coordinator 5 might automatically search the expert knowledge module 9 for knowledge relating to “advertising creative development.” If the system fails to recognize the user's inputted “type” of project 24, the system might display a message stating that such is the case and requesting the user to try again, and/or provide choices of recognized types which might have been intended. However, assuming a marketing module 10 exists for “advertising creative development”, the system coordinator's 5 keyword search capabilities should allow the system coordinator 5 to effectively match the user's input of “type” of project 24 with all the knowledge that is available in the expert knowledge module 9. Once the system coordinator 5 recognizes the “type” of project 24, the system coordinator would make the knowledge-accessible to the user, or may also make some portion of the knowledge an integral part of the user's workspace such as providing the user with a step-by-step template. Integrating a portion of the knowledge, such as a step-by-step template, within the user's desktop should provide the user with a workflow that guides the user to a solution to the identifiable problem.

In more detail, FIG. 4 depicts an exemplary global framework for all advertising and marketing development and deployment in a marketing knowledge module embodiment. In the illustrated setup, no matter the “type” of project 24 defined by the user, it will fall into several categories, including but not limited to, strategy, plan and process renewal 21, strategy and plan development 22, or create and deploy 23. Create and deploy comprises customer and customer proposition creation including the development and deployment of concepts, advertising, promotions, public relations, pricing, product availability plans, research and packaging. Corresponding to each of these three categories is a predetermined global framework (21f, 22f, and 23f, respectively), that defines where the specific project falls. For example, if the “type” of project 24 is “advertising creative development”, the system coordinator 5 may recognize that the project might fall under the create and deploy 23 framework and the system coordinator 5 might alert the user that it recognizes the user's inputted “type” of project. In an exemplary embodiment of the present invention, once the system coordinator 5 recognizes the “type” of project 24, it highlights the category on the users screen as well as the position within the framework that the “type” of project falls, as depicted in FIG. 5 (cross-hatching indicates highlighted or illuminated portions).

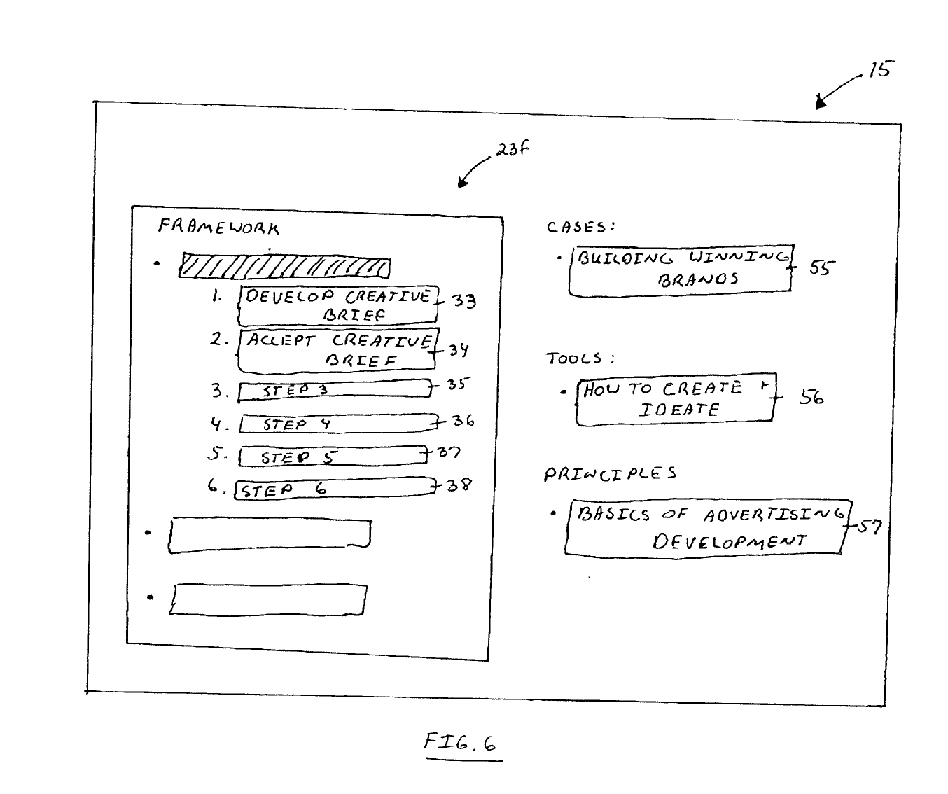

At this point, the user is prompted to “click” on the appropriate global framework category as in this case, the create and deploy category 23. After “clicking” on the category, the system coordinator 5 may embed, or provide the user access to, a portion of the expert knowledge within the framework as illustrated in FIG. 6. For example, a possible web screen 15 presented to the user might display the global framework as well as the integrated workflow. In more detail, as depicted in FIG. 6, the expert knowledge embedded into the user's workflow may comprise steps 1-6 (i.e. 33, 34, 35, 36, 37, and 38). It should be recognized that for the user to complete the advertising creative development, the user must complete these steps. Additionally, it should be recognized that the number of steps provided to the user should vary depending on the user's inputted “type” of project 24.

Moreover, not only is the step-by-step template made available to the user, thereby creating a workflow for the user, but the appropriate case studies, principles, tools and/or other knowledge are also provided for selective user access. In particular, it is contemplated that no matter the user's position within the workflow, a series of selectable icons containing examples of principles, case studies, reference material, treatises or texts, and/or tools and other knowledge are made available to the user to aid the user in solving each step of the contemplated workflow. For example, steps 1-6 as depicted in FIG. 6 are the broadest steps associated with the development of the advertising creative development. At this point, for example, the user could choose the case study “building a winning brand” 55, the tool “how to create and ideate” 56 or the principle “basics of advertising development” 57, which should be the most relevant knowledge in the expert knowledge module 9 relating to the steps 1-6 of the contemplated workflow. Thus, if the user was unsure how to complete a particular step of the contemplated workflow, the most relevant case studies, principles, tools and other knowledge would be available to aid the user.

It should further be recognized from the forgoing that although the example of FIG. 6. contemplates only one case study, principle, and tool, there may in fact be a multitude of such examples. Moreover, while the example also limits the expert knowledge to case studies, tools and principles, other types of knowledge such as algorithms, concepts, demographic studies and the like could also be integrated into the workspace. It is contemplated that the expert knowledge made available to the user provides the user with enough information to allow the user to solve every step associated with the contemplated workflow.

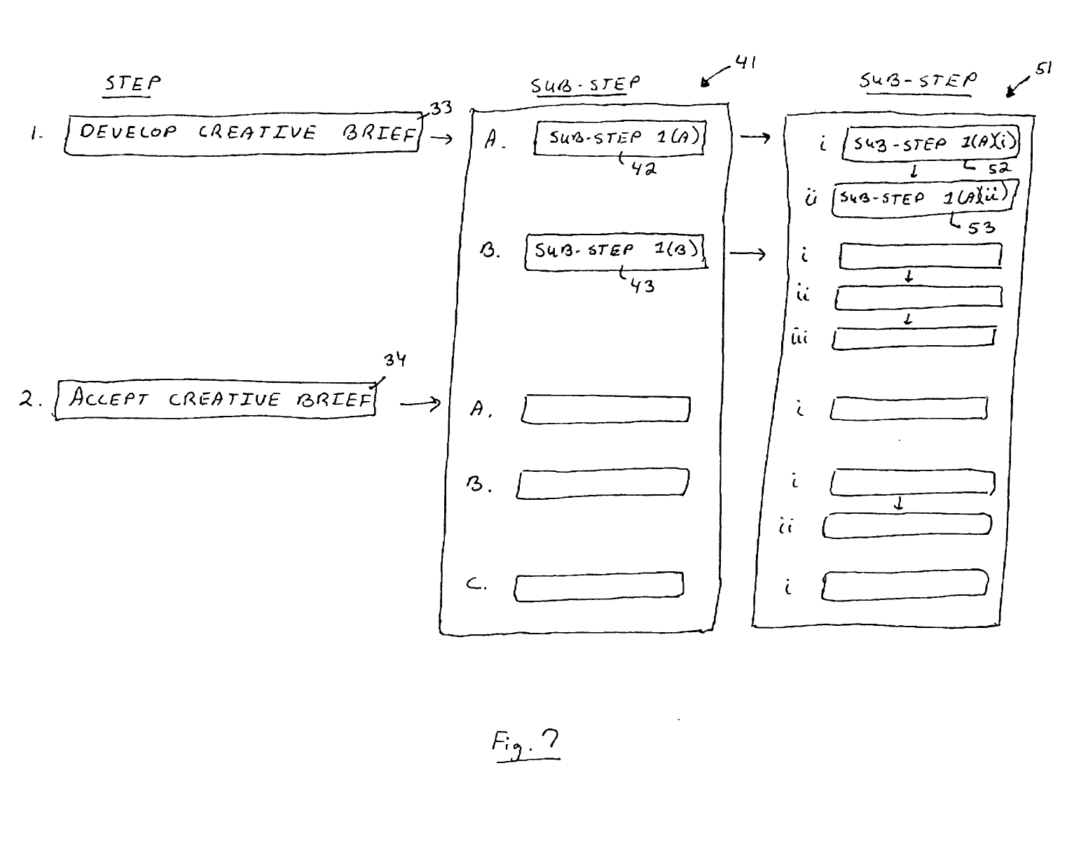

Continuing, from a conceptual standpoint, it should further be recognized that each step 1-6 may further comprise a plurality of sub-steps 41, which may also comprise a further plurality of sub-steps 51 as depicted in FIG. 7. For example, it should be recognized that to complete step 1 as indicated by numeral 33, sub-steps 1(A) and 1(B) as indicated by numerals 42 and 43, respectfully, must be completed. Moreover, by way of example only, to complete sub-step 1(A) as indicated by numeral 42, sub-steps 1(A)(i) and 1(A)(ii) as indicated by numerals 52 and 53, respectively, must similarly be completed. In this way, a user is guided in a step-by step approach by the interactive system 1 to one or more solutions to the identifiable problem. Additionally, it should be noted that although the interactive system 1 allows the user to “skip” steps or work in any order the user desires, in an exemplary embodiment of the invention, the interactive system 1 encourages the user to follow the step-by-step approach. Encourages is contemplated herein to mean that the system coordinator 5 may prompt the user to follow the step-by-step approach, but the coordinator 5 will preferably not prevent the user from “skipping” steps in the workflow. The purpose of allowing user's to skip steps is to allow user's with a greater understanding of marketing or developing a marketing campaign to somewhat personalize their workflow. Since some steps in the process may be trivial to a user with experience, it is contemplated that the user be allowed to “skip” these steps. Nonetheless, the system 1 will encourage all users to following the appropriate step-by-step template provided by the system. It should further be recognized that the system 1 might redirect users to an appropriate starting point, should the user “skip” to a stage in the development that is unfamiliar to the user or a place where the user is unable to fully understand the requirements of the step.

It should be recognized that the knowledge within the workspace provides a user a complete solution to the user's identifiable problem if the user follows the workflow in the appropriate step-by-step approach. Moreover, it should also be recognized that the interactive system 1 provides the user the ability to re-assess each stage of the identifiable marketing project. For example, once a user develops a solution to an identifiable project, or develops a solution to a particular step in the workflow, the user might have the opportunity to test or verify the quality of the solution. Moreover, the user's particular solution to a particular step may be made available of other members of the team to review such as a supervisor, or perhaps even the client-end user. Should the solution, for whatever reason, fail to meet expectations, it is contemplated that the system 1 might allow the user to revisit and re-access any step or stage in the development process. Additionally, the fact the solution was developed in a collaborative virtual work environment (i.e. multiple persons from anywhere in the world) should provide the opportunity for every user to efficiently re-assess that particular stage he/she was involved in without duplicative effort. As such, the interactive system 1, allows the user and/or the team to continually archive data for review on a real-time basis. In this way, users can modify their results to the workflow and instantly re-deploy the renewal effort. This benefit should minimize time, effort and expense involved in developing a solution to an identifiable marketing problem. Continuing, it is contemplated that the interactive system 1 provides the user with not only the complete step-by-step approach, but also provides a status overview of the work that has been completed and the work that needs to be completed. For example, it is contemplated that the system 1 will provide the user with an indication of the steps that have been “completed”, the step currently being developed and the steps that are “not completed”. In this way, a user could be made aware of the step with which he/she is working and how that step “fits” with respect to the entire project. As such, the interactive system 1 should facilitate faster time to market and reduced costs for the creation, development and deployment of marketing projects.

It is further contemplated that the knowledge embedded into a user's desktop or workspace is customizable by the user. It is contemplated that a user will be able to select from a screen, such as a preferences screen, whether categorizable knowledge relating to a particular topic, industry, or other factor will be embedded in the user's workspace. For example, if the user is familiar with every case study in the expert knowledge module 9 relating to “creating dot-com advertisements”, the user will have the option to elect to not have such categorized knowledge embedded in the user's workspace. In other words, when a user creates or opens a particular project, the system coordinator 5 will not embed the particular case study or group of case studies in the user's workspace. It should be recognized that once a user modifies preferences, the system coordinator 5 should be capable of storing the user preferences in the system data store 11. In an exemplary embodiment, the preferences might be stored in either the already developed user identification or user profile record. As such, subsequent use of the interactive system 1 by the user will not require the user to re-enter her preferences.

In addition, it is contemplated that the user might have access to expert consultants 47 or to information collected by reputable and independent third party research institutes such as Nielson, IRR and other marketing and advertising agencies. In particular, if the user has a particular question or is unable locate a resource, the user might be able to contact an expert human consultant for advice. The contact might be established through any variety ways including, e-mail, text messaging, or phone contact. Moreover, it is also contemplated that the user have the capability to search or otherwise receive knowledge from the independent third party research institutes.

It is further contemplated that the present invention comprise a tutorial 61 in communication with the system coordinator 5. The tutorial 61 might provide a list of frequently asked questions 62, a suggestion box 63, or provide an overview or demonstration of the interactive system 1, or the like. The tutorial 61 might also be accessible at any time and from any web page 15 to provide an individual user access to the expert knowledge module 9. In this regard it is contemplated that an individual user could ask a specific question at the tutorial screen and the system coordinator 5 would search the expert knowledge module 9 for information relating to the question. The results would thereafter be categorized by relevance and displayed to the user.

In another embodiment of the present invention, the interactive system 1 may further comprise a user data store 60 for storing a user's information. User information is contemplated herein to comprise project work and data created by the user such as inputted information regarding a particular project, items relating to the user's personal calendar, to do list, saved e-mail messages, uploads, downloads, responses to the step-by-step templates, or any other information created by the user. It should be recognized that the user data store 60 could be an integral or separate data store from either or both of the expert knowledge module 9 and system data store 11.

In another embodiment of the invention, it is contemplated that the users would have access to a portal module 65, which would be in communication with the system coordinator 5. The portal module 65 is contemplated as providing users access to interactive chat-rooms, bulletin boards, external e-mail systems, business-to-business exchanges and to variety of Internet links. It is contemplated that an option might be made available where individual users can set up secure, direct communication links for more specialized interaction. Again, these various options can be currently provided in the form of software commonly available in the industry. For example, a chat room arrangement could be set up through existing technology as available from software providers.

It is further contemplated that the interactive system 1 might comprise a watch or alert system 70 in communication with the system coordinator 5. The watch or alert system 70 might provide users with an alternate means of receiving knowledge from the expert knowledge module 9. For example, it is contemplated that an individual user may set a preference in the system coordinator 5 to alert the user to any new knowledge or a specific variety of knowledge added to the expert knowledge module 9 relating to a particular subject. Thus, upon a system administrator, as will be further defined, updating the expert knowledge module 9, an individual user could be made aware of the updates.

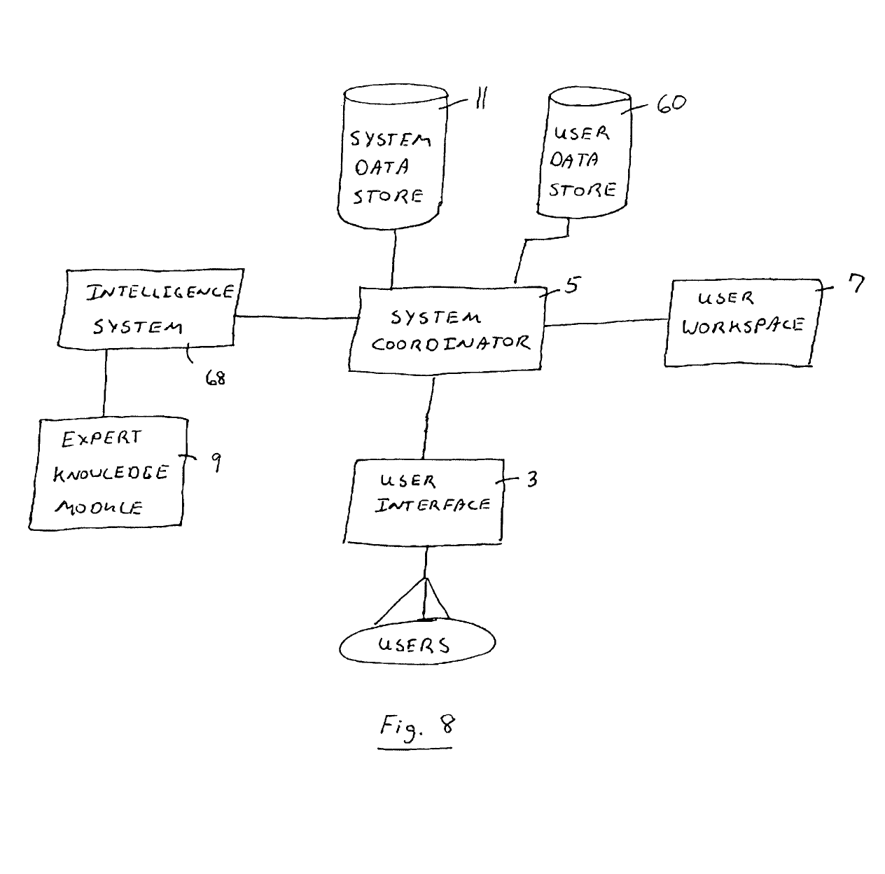

In an alternate embodiment of the present invention, as depicted in FIG. 8, the interactive system 1 may further comprises an intelligence system 68 in communication with the system coordinator 5. In this embodiment, the intelligence system 68 might preferably be in communication with one or more expert knowledge modules 9 and might comprise a set of executable instructions such as software, routines, programs, algorithms, code and the like, for determining knowledge from the module 9 to be selectively distributed to the user.

It is contemplated in this embodiment that the intelligence system 68 will comprise some level of artificial intelligence that might enable the system to effectuate a personalized relationship with each individual user. To affect such a personalized relationship, it is contemplated that the intelligence system 68 might differentiate users based upon their level of experience, experience with the system, associated industry, type of material typically read, level of difficulty of reading material, and a multitude of other factors. In this way, the interactive system 1 might be able to effectuate a personalized relationship with each user, and thereby enhance the user's experience by providing tailored marketing material to the user based on the users preferences and experiences. For example, the intelligence system 68 might be able to recognize that a recent college graduate having no experience in the field and no experience with the interactive system 1 would have significantly less experience than a senior marketing manager having 10 years of professional experience and having developed several marketing campaigns through the interactive system 1. Consequently, the interactive system 1, might be able to provide more advanced case studies, tools, principles and the like to the senior marketing manager than the college graduate.

It is further contemplated that the interactive system 1 further comprise an administration access component 90 for system supervision, maintenance, upgrades and general monitoring of the interactive system 1 by a system administrator. While this administrative component 90 could be located on site with the system server in some applications, in other embodiments it may be preferable that the administrative component 90 have the ability to access the interactive system from remote locations. Particularly, where redundant systems, regional data centers or system servers, offsite backup systems, or where the various elements of the interactive system 1 such as the system coordinator 5 and the expert knowledge module 9 are housed separately, the administrator user will need ready access to any and all components at any time.

As is apparent from the preceding detail, the interactive system 1 may require a plurality of computers to telecommunicate with each other and share information, applications and/or services. In this setting, the various computers are referred to as nodes, which is a generic term referring to an access point in a interconnected system. One type of computer network which might be employed in a specific embodiment of the invention is a client/server architecture, wherein the portions of network applications that interact with human users are typically separated from the portions of network applications that process requests and information. Often, the portions of an application that interact with users or access network resources are called client applications or client software, and portions of an application that process requests and information are called server applications or server software. Client machines tend to run client software and server machines tend to run server software, however a server can be a “client” as well. In an exemplary embodiment of the invention, the user interface would be typically provided on a client machine (which might be any of the user interface alternatives contemplated and exemplified above such as a network computer, stand alone computer, interactive kiosk, etc.) and the software containing the computer instructions which comprise the methods according to the present invention would be located on a server computer, separate from the client machine.

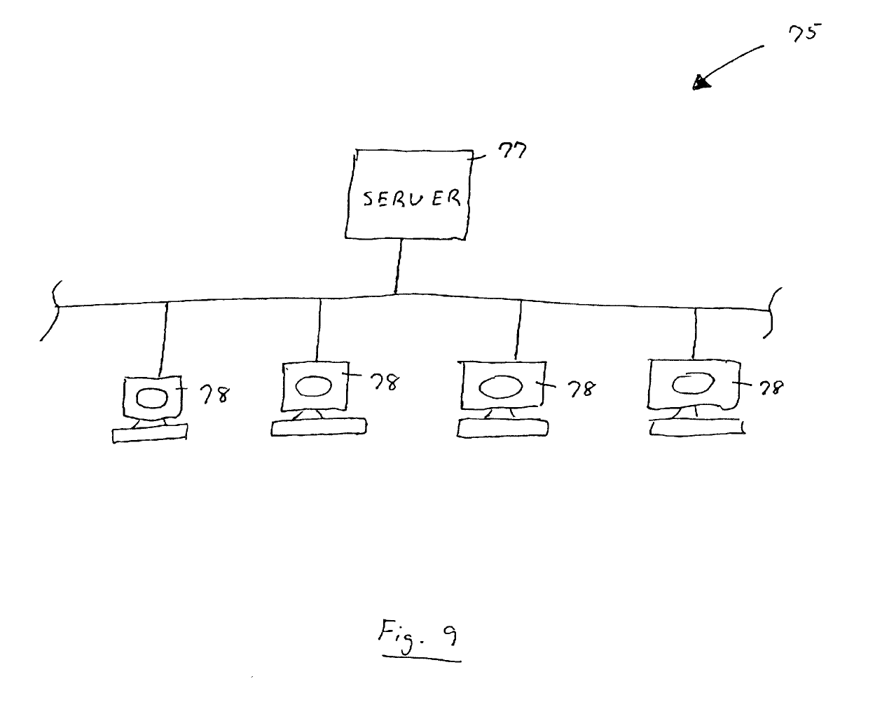

FIG. 9 schematically illustrates a sample client/server diagram 75 which might be employed to implement an embodiment of the present invention. As one with ordinary skill in the art will readily appreciate, a client/server network is only one type of network, and a variety of other configurations, such as peer-to-peer connections, are also considered networks. In a client/server network, a plurality of nodes are interconnected such that the various nodes send and/or receive information to/from one another. As shown here, a server node 77 is interconnected with a plurality of client nodes 78 using a connection 79 such as a token ring, Ethernet, telephone modem connection, radio or microwave connection, parallel cables, serial cables, telephone lines, universal serial bus “USB”, Firewire, Bluetooth, fiber optics, infrared “IR”, radio frequency “RF”, and the like, or combinations thereof.

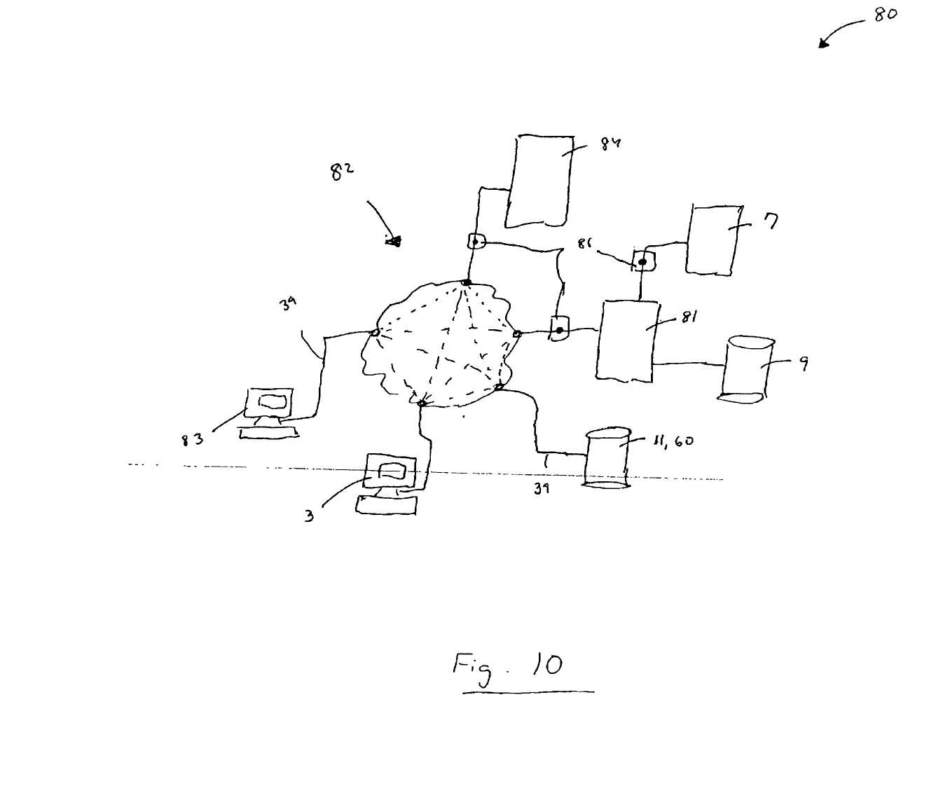

Furthermore, an exemplary embodiment of the network system is depicted in FIG. 10. The network system 80 comprises a server 81, such as available from Dell, Hewlett-Packard, Sun Microsystems, IBM, or any other number of manufacturers The server 81 is preferably in communication with an expert knowledge module 9, which might be a database such as an Oracle® 8i database. Moreover, the server 81 may also be provided with at least one software module 8 which might provide the virtual work environment for the users. Examples of software module applications may include applications as available from Sun Microsystems, Microsoft Corporation, and the applications may be compatible with a variety of operating systems such as NT, Linux, Unix, OS/2 and the like. The network system 80 may further comprise a redundant server 84 to accommodate diversity in customer base as well as provide a real-time back-up should either server 81, 84 fail. Additionally, it should be recognized that the servers 81, 84 and/or data stores 11, 60 could be provided with firewalls to protect the interactive system 1 from unauthorized use.

As further shown in FIG. 10, the network system may further comprise as either separate or integrated components a system data store 11 and a user data store 60, which might also be a database such as the Oracle® 8i. The database is connected to the server 81 through a connection node 39 on a network. As suggested, one in the art will readily appreciate that the server 81 could comprise the expert knowledge module 9, system data store 11 and user data store 60. Alternatively, these components could be located anywhere in the world that is in communication with the Internet 86. The Internet 86 is comprised of numerous webs of connections that cover the entire world allowing a user to interact with the interactive system through a user interface 3 such as a computer anywhere in the world, as long as the user interface is connected to the Internet. The user interface might be a desktop computer such as available from IBM, Dell, Gateway, Apple, and a variety of other manufacturers. The computer may comprise a modem for a dial-up connection to a local Internet service provider, or may connect to the Internet 86 through an xDSL line or a cable modem. The interactive system 1 might further comprise an administrative computer 83 which allows a system administrator access to the expert knowledge module 9, the server 81, the redundant server 84, and the software modules 8. This embodiment allows a system administrator to access these components at any time and from any location in the world.

### EXAMPLES

The following examples depict two typical scenarios of users interacting with an interactive system of the present invention directed to the marketing industry. Example One depicts an exemplary interaction by a fictional user “Jeff,” and Example Two depicts an exemplary interaction by a group of users “Mike” and “Pat”.

### Example One

Jeff, a recent college graduate starting his first project with Marketing Company, is asked to develop a brand name for a new consumer product. Since Jeff has no prior practical experience, he is unsure how to undertake his first project. However, Jeff is made aware from his supervisor or colleague that the inventive interactive system could provide him with the necessary tools to accomplish the task. As a result, Jeff decides he is willing to sign up for the service and embark on his first experience developing a brand name.

Jeff begins by using a desktop personal computer having, for example, a CPU, memory, a monitor and keyboard, or other data input device with access to the Internet. Jeff connects to the Internet through an Internet Service Provider and opens Internet Explorer web browser software on his computer. Jeff then finds and enters the URL address associated with the subject interactive system 1 and the web browser sends the URL request to a web server, hosted by the interactive system, through the Internet. The web server sends a command instruction back to Jeff s computer to check for the presence of a cookie corresponding to the interactive system 1. Finding no cookie, the web server sends a command to the system coordinator 5 identifying Jeff as a new unknown first time user and the system coordinator 5 selects and transmits a corresponding and appropriate introductory web page 15.

Jeff acknowledges the introductory web page 15 and proceeds to sign-up for the services offered. Jeff enters the information required to sign up, including a desired user name and password, and transmits the information to the web server. The system coordinator 5, compares the user input against the decision tree and executes the predetermined instructions associated with the matching branch of the tree. In this particular example, the system coordinator 5 creates and stores a user identification record in the system data store 11 to be associated with the new account.

The system coordinator 5 might next open an appropriate introductory screen or series of screens before opening a workspace screen that provides Jeff with all the necessary tools such as e-mail, messaging, assess to Microsoft applications, access to the “Expert” and the like. Since, in this example, Jeff has never been on the system before, he may choose a tutorial button 26 located upon one of the introductory web pages 15. Upon selecting the tutorial button 26, the system coordinator 5 should transmit the tutorial screen to Jeff.

The tutorial screen transmitted to Jeff may include a list of typical starting topics such as frequently asked questions, or may provide Jeff a demonstration of the interactive system 1, or may allow for specific typed in question. Jeff might thereafter acknowledge the tutorial screen and select the typical starting topic of “touring of the system” or “how-to use the system” or the like. In this particular scenario, the system coordinator 5 would provide Jeff an interactive overview of the system, including, for example, how to open, create, and modify documents, how to use “the Expert” or generally how to navigate in the interactive system 1. Once Jeff has completed the “tour”, the workspace screen might once again be presented to Jeff by the system coordinator 5.

Jeff, now being more comfortable and confident with interacting with the system 1 might decide he is ready to begin working on his project. Consequently, Jeff selects “the Expert” icon from the workspace screen 13 to begin his initial work on the brand-naming campaign. Upon selecting the icon, the system coordinator 5 communicates with the appropriate software module 8, and directs “the Expert” screen, as in FIG. 4, to be opened. The program user interface is also transmitted to Jeff s workspace, which allows Jeff to begin his work, such as in this particular example, creating a new project.

When initially creating the project, the Expert requires that Jeff define the “type” of project 24 such as, by way of example only, advertising creative development, concept development, free standing insert, and the like. Jeff s selection of the type of project 24 triggers the system coordinator 5 to search the expert knowledge module 9 for expert knowledge relating to Jeff s identifiable project. Upon recognizing the type of project 24, the system coordinator 5 embeds the knowledge from the expert knowledge module 9 within the desktop of the user thereby creating a workflow for Jeff to follow to find one or more solutions to the identifiable problem. For example, as depicted in FIG. 6, the web page displayed to the user may comprise a multitude of steps for Jeff to follow, which should guide him to formulate a solution to the problem.

Jeff may begin by selecting step 1, or as depicted in FIG. 6, developing a creative brief 33. Upon selecting the icon 33, a second series of steps, or sub-steps 41 as depicted in FIG. 7, may be displayed to Jeff. Jeff should recognize that completion of each of these sub-steps, will lead to completion of step 1, developing a creative brief, as related to the overall workflow process. In this particular example, assume that Jeff has completed sub-step 1(A) as depicted by numeral 42 in FIG. 7 and that Jeff is currently working on sub-step 1(B) as depicted by numeral 43. Sub-step 1(B), for example, might require Jeff to determine the demographics of the brand's potential users. Jeff, being unfamiliar with consumer demographics, might determine that he needs guidance with how to continue and the best approach for developing an answer.

Jeff recognizes that a tool bar on the screen will allow him to obtain expert knowledge in the form of tools, case studies, reference material, treatises or texts, principles, and even consulting if he so desires. Jeff might then select a case study to read. After reading and analyzing that case study, Jeff might decide to review more case studies, or might decide to review principles or tools to obtain further knowledge. In this way, the interactive system 1, provides Jeff with all the resources necessary on his workspace to determine/develop an appropriate answer the consumer demographic question associated with the workflow process at sub-step 1 (B) depicted by numeral 43 in FIG. 7.

Lets assume that Jeff has spent his first day working through the first part of the workflow, but now decides its time to wrap it up and go home. Jeff selects a “save” button for example, to save the information he inputted in a file and to save his place within the established workflow. By selecting the save button, the system coordinator 5 communicates with the software module 8 to save the file in Jeff s user data store 60. Jeff might be asked to “name” the project file for easy future identification, such as in common software filing applications. The coordinator also saves in the system data storage 11 the exact step or sub-step where Jeff was last working, so the next time Jeff enters the system he can “recall” to the position he was at prior to going home for the day.

### Example 2

In this scenario, assume that Pat is an experienced executive, on the West coast that asks Mike, a ten year experienced marketing professional on the East coast to help him develop a marketing video. Pat suggests that they collaborate on the project using a marketing system that provides a complete vertical marketing solution. Pat has been a long time user of the system and already has some information relating to the video stored on the system.

Like Example One, Pat begins by using a desktop personal computer and accessing the Internet through a Service Provider. Pat enters the URL address of the interactive system 1 and the web browser sends the URL request to a web server, hosted by the interactive system. Similar to Example One, the web server sends a command instruction back to Pat's computer to check for the presence of a cookie corresponding to the interactive system. Since Pat has been on the system before, the web server finds a cookie and transmits the information to the system coordinator 5 identifying Pat as a returning user.

Upon recognizing Pat as a returning user, the system coordinator 5 request's Pat's username and password and compares it to Pat's user identification record stored in the system data store 11. Next, the system coordinator 5 might search the expert knowledge module 9 on an alert 70 set by Pat for knowledge added to the interactive system such as recent cases, tools or principals that have been added to the system since Pat's last use. Thereafter, the system coordinator 5 might provide an appropriate introductory screen to Pat's desktop or workstation, which allows Pat to, among other things, review his projects, to do list, message center, calendar, recent marketing news, and the like.

Pat being comfortable with interacting with the system 1 might decide he needs to modify a project including a video work in progress. Consequently, Pat might select the Expert icon, upon which the system coordinator 5 opens the appropriate software module application 8 and displays a listing of Pat's projects as illustrated in FIG. 5. Pat might subsequently select the video project to begin working. Upon selecting the video project, the system coordinator may recall from the system data store 11 Pat's position within the workflow and, for example, the interactive system 1, may also show the status of each step in the workflow. At this point, Pat not only has the option of reviewing knowledge embedded by the system coordinator 5 into her workspace, but she also has the option of inputting, creating, modifying, editing, and the like information relating to the development of the video.

While Pat is modifying her video project, Mike signs onto the interactive system 1 for the first time. Similar to Example One, Mike must sign-up as a new user and must select a desired user name and password. The system subsequently creates a user identification record for Mike and stores the record in the system data store 11.

Since, Mike is new to the interactive system 1, he may also wish to understand the system better by receiving a “tour” of the system. After Mike completes the tour and he feels confident interacting with the system, the system coordinator displays Mike's workspace or desktop. Since Mike intends to collaborate with Pat on the Video project, Mike may then select a “collaborate” icon on the desktop so he and Pat can collaborate on the video project. Upon selecting the “collaborate” button, the system coordinator 5 sends instructions to the software module 8 to allow Mike to “join” Pat in a virtual combined work session. Mike maybe asked to input predetermined information such as the username of the person he desires to collaborate with, or a team name, and an appropriate password before the interactive system 1 allows Mike to join Pat in the collaborative session. Once Mike transmits the required information, such as a username or team name and password, a software module 8 such as a user collaboration facilitator might allow both Mike and Pat to collaborate in real-time on a given project.

Upon completion of the project, Mike might exit from the collaboration software module, and might exit the system or might go onto create another project. Likewise, Pat may also exit the system, or may go onto create or modify another project.

The examples and specific embodiments set forth herein are for illustrative purposes only and not intended to limit the scope of the methods and fabrics of the invention. Additional methods and fabrics within the scope of the claimed invention will be apparent to one of ordinary skill in the art in view of the teachings set forth herein.

What is claimed is:

1. An interactive system for creating a user workflow comprising a user workspace in selective communication with an expert knowledge module comprising a predetermined area of knowledge, wherein said system is configured to systematically guide a user toward a solution to an identifiable user project.

2. The interactive system of claim 1, wherein a plurality of software applications define said user workspace.

3. The interactive system of claim 1, wherein said system selectively accesses knowledge from said expert knowledge module which guides the user toward a solution to the identifiable project.

4. The interactive system of claim 1, wherein knowledge from said knowledge module provides said workflow for the user to solve the identifiable project.

5. The interactive system of claim 4, wherein said workflow is defined by at least one interactive step-by-step template.

6. The interactive system of claim 5, wherein each step of said step-by-step template further corresponds with knowledge comprising at least one of the following: cases studies, tools and principles.

7. The interactive system of claim 1, wherein knowledge from said knowledge module is selectively provided to a user based at least in part on a predetermined type of project.

8. The interactive system of claim 1, wherein said knowledge module further comprises at least one marketing sub-module.

9. The interactive system of claim 1, further comprising user data storage for selective storage of project work and data created using the interactive system.

10. The interactive system of claim 1, further comprising system data storage for selective storage of user identification records created using the interactive system.

11. The interactive system of claim 1, further comprising a tutorial for providing a user with guidance for navigating within the interactive system.

12. The interactive system of claim 1, further comprising an alert system for alerting the user to further knowledge added to and modifications made to said expert knowledge module.

13. An interactive system for providing a user access to a predetermined area knowledge within a user workspace comprising:
a user interface;
an expert knowledge module comprising a predetermined area of knowledge;
a system coordinator comprising executable instructions in communication with said a user interface, said expert knowledge module, and said user workspace, said coordinator further comprising executable instructions for providing access to said predetermined area of knowledge to guide the user toward one or more solutions to an identifiable project.

14. The interactive system of claim 13, wherein said user workspace is defined by at least one software module.

15. The interactive system of claim 13, wherein said knowledge creates a workflow for the user to solve the identifiable project.

16. The interactive system of claim 13, wherein said knowledge further comprises at least one of the following: step-by-step templates, case studies, tools, and principles.

17. The interactive system of claim 13, wherein said selective access to knowledge within said expert knowledge module is based at least in part on a predetermined type of project.

18. The interactive system of claim 13, wherein said knowledge module further comprises at least one marketing sub-module.

19. The interactive system of claim 13, wherein said knowledge is capable of being categorized.

21. The interactive system of claim 13, wherein said system coordinator is provided with one or more predetermined web pages for directing user interaction.

22. The interactive system of claim 13, wherein said system coordinator is provided with executable instructions for providing access to information in the form of frequently asked questions, a suggestion box and consulting services.

23. The interactive system of claim 13, wherein said system coordinator is in selective communication with an Internet portal.

24. An interactive system for providing networked based solutions and expertise to users in a predetermined area of knowledge comprising:
a user interface;
an expert knowledge module comprising a predetermined area of knowledge sufficient to guide a user to a solution of a user identifiable project; and
a system coordinator comprising executable instructions for providing selective communication with said expert database based at least in part on input from the user and for providing output to said user interface to help the user learn about the identifiable project and to guide the user toward one or more solutions to an identified project.

25. The interactive system of claim 24, wherein said system coordinator further comprises executable instructions for providing selective access at said user interface to one or more related software application modules.

26. The interactive system of claim 25, wherein said software application modules define a user workspace.

27. The interactive system of claim 26, wherein said output is embedded into the workspace of the user.

28. The interactive system of claim 27, wherein said embedded output within said workspace creates a workflow for the user to solve the identifiable problem.

29. The interactive system of claim 25, wherein said input from said user comprises a predetermined type of project.

30. A method for providing selective access to a predetermined area of knowledge within a user's workspace comprising:
providing a user interface;
providing a user workspace in communication with at least one software application module defining said workspace and in communication with an expert knowledge module;
accepting user input through said user interface;
selecting knowledge from said expert database based on said user input;
providing access to said knowledge to said user.

31. The method of claim 30, further comprising the step of creating a workflow based on said knowledge from said expert knowledge module.

32. The method of claim 30, further comprising the step of further providing a system coordinator in communication with said user workspace and said expert knowledge module with a set of executable instructions for providing access to said knowledge within said workspace.

33. A method for guiding a user to a solution to an identifiable problem, comprising:
providing an expert knowledge module comprising expert knowledge in communication with a user interface;
accepting user input through said user interface;
selecting knowledge from said expert knowledge module based on said user input;
providing said selected knowledge to said user interface;
repeating the foregoing steps until user termination.

34. A computer-readable medium containing instructions for controlling a computer system to interact with a user to guiding a user to a solution to an identifiable marketing problem, comprising the steps of:
providing an expert knowledge module comprising expert knowledge in communication with a user interface;
accepting user input through said user interface;
selecting knowledge from said expert knowledge module based on said user input;
providing said selected knowledge to said user interface;
repeating the foregoing steps until user termination.

35. A computer data signal embedded in a carrier wave for transmitting executable instructions for interactively guiding a user to a solution to an identifiable marketing problem,
the signal comprising the instruction:
providing an expert knowledge module comprising expert knowledge in communication with a user interface;
accepting user input through said user interface;
selecting knowledge from said expert knowledge module based on said user input;
providing said selected knowledge to said user interface;
repeating the foregoing steps until user termination.
